(19) United States
(12) Patent Application Publication
(10) Pub. No.: US 2014/0260992 A1
(43) Pub. Date: Sep. 18, 2014

(54) ROTATING CLEANER ARM FILTER

(71) Applicant: CAMBRIDGE INTERNATIONAL INC., Cambridge, MD (US)

(72) Inventors: Melody Elizabeth FERNAAYS, Arnold, MD (US); Maxwell Lawrence KEELING, Cambridge, MD (US); Matthew Charles O'CONNELL, Cambridge, MD (US)

(73) Assignee: CAMBRIDGE INTERNATIONAL INC., Cambridge, MD (US)

(21) Appl. No.: 14/217,943

(22) Filed: Mar. 18, 2014

Related U.S. Application Data
(60) Provisional application No. 61/800,389, filed on Mar. 15, 2013.

(51) Int. Cl. B01D 46/00

(52) U.S. Cl. CPC B01D 46/0071; B01D 46/0068
USPC 96/229; 55/294

(57) ABSTRACT

A filter for removing a particulate material includes a collection system provided in an air stream to collect the particulate material, the collection system including a filter frame having a plurality of filter panels, and a cleaning system provided to clean the collected particulate material from the plurality of filter panels, the cleaning system including a rotatable cleaner arm having a plurality of nozzles.

### TECHNICAL FIELD

The present invention relates to a rotating cleaner arm filter, more particularly to a rotating cleaner arm filter which removes particulate material collected on a filter media, and still more particularly, to remove moist and/or sticky particulate collected on a filter media.

### BACKGROUND

Conventionally, air purification is performed to remove various types of fine particulates contained in process gases which could damage downstream equipment used in various industries.

Previous air stream filtration methods include, for example, electrostatic dust precipitators, cyclone separator systems, and rigid ceramic filters, each of which has suffered from certain drawbacks and inefficiencies.

It is an object of the disclosure herein to provide a gas filtration system with improved reliability and efficiency, and in particular, a gas filtration system capable of filtering air streams which carry moist and/or sticky particulates.

### SUMMARY

These and other objects of the disclosure herein are provided by a filter for removing a particulate material comprising a collection system provided in an air stream to collect the particulate material, the collection system including a filter frame having a plurality of filter panels, and a cleaning system provided to clean the collected particulate material from the plurality of filter panels, the cleaning system including a rotatable cleaner arm having a plurality of nozzles.

### BRIEF DESCRIPTION OF THE DRAWING FIGURES

These and other objects, features, and advantages of the disclosure will become more readily apparent to those skilled in the art upon reading the following detailed description, in conjunction with the appended drawings in which:

FIG. 1 is a perspective view of a gas filtration system according to a first exemplary embodiment of the disclosure, with portions of the housing and drive system removed for clarity.

FIG. 2 is a perspective view of the rotating cleaner arm filter in the system shown in FIG. 1.

FIG. 3 is a schematic illustration of the air flow path in the system shown in FIG. 1.

### DETAILED DESCRIPTION

A rotating cleaner arm filter 10 in accordance with an exemplary embodiment of the disclosure is shown in FIGS. 1-3. Filter 10 includes a collection system 100 comprising a frame 102 with a plurality of filter panels 104 which collect particulate from the air stream, and a rotating cleaner arm 200 which removes the particulate adhered to the collection system 100 and forces the particulate particles back into the solid air stream. The filter 10 is particularly suited for use with gas or air streams which carry particulates of various sizes that are moist and/or sticky such as tar, for example. The filter 10 thus blocks particulate from moving downstream to equipment such as a fan or heat exchanger, which in turn, extends the periods between maintenance, repair and other downtime.

The frame 102 is hull-shaped, preferably semi-circular, and includes the plurality of filter panels 104 containing a filter media. The filter panels 104 are stationary and individually replaceable from the outside (exterior) of the semi-circular frame 102. The particulate within the air stream is collected on the exterior surface of the hull-shaped frame 102. A rotating cleaner arm 200 is located on the clean side of the filter 10 (the interior of the semi-circular frame). The rotating cleaner arm 200 blasts air or other gaseous or liquid fluid through the filter media to dislodge the collected particulate and thereby clean the particulate collection system 100. The rotating cleaner arm 200 includes a plurality of nozzles 202, the arm 200 rotates the nozzles in a 180 degree sweeping action, back and forth across the frame 102 to clean filter media therein. Nozzles 202 are preferably located at the distal tip of the cleaning arm 200 and are adapted to pump compressed air, water, and/or various other fluids therethrough to clean filter panels 104 on the opposite side of particulate collection. Due to its hull or semi-circular shape, the frame 102 provides equal nozzle distance from all the filter panels 104. Cleaner arm 200 is actuated from outside the air stream, and houses plumbing for air or fluid to pump through the nozzles 202. An access panel 204 provides access to cleaner arm 200 and fan 206 from inside of the air stream, and blocks particulate from flowing into the fan without going through filter 10.

Referring also to FIG. 3, air flows through a solid stream, and then the air and particulate are sucked toward filter 10 by fan 206. Particulate collects on the filter media on a first surface of filter panels 104, and cleaner arm 200 intermittently rotates along an opposing second surface of filter panels 104, thus pushing particulate back into solid stream at a higher velocity than air flowing in. As a result, clean air flows through downstream equipment, and clean air is exhausted to solid stream to start the cycle again.

A motor associated with a drive system 208 rotates cleaning arm 200, while controls establish time increments of cleaning. Nozzles 202 are sectioned off and solenoid valves allow for certain sections to be cleaned intermittently. This allows for focus on a certain filter area if needed, and an overall decrease in air consumption. The type of fluid used for cleaning off the particulate from the filter is controlled from valves outside of the filtration system as well.

The filter 10 according to the disclosure herein is advantageous because the filter 10 maximizes the amount of surface area exposed to the air stream with its hull shape allowing for an increase in particulate collection. The filter 10 is a relatively compact design that can be placed inside of a current system installation, so as not to reduce floor space. The filter 10 effectively filters particulate particles of various sizes that include tar and moisture. The filter 10 has replaceable filter panels that can be individually switched.

The filter 10 according to the disclosure herein is also advantageous because, since all collected particulate is forced back to solid stream, there is zero waste removal required.

Further, having the control of cleaning arm 200 and position monitoring located outside of air stream, allows operators to easily manipulate the cleaning cycle.

Various fluids can be pumped through the system by changing valve openings. Cleaning inside of filter 10 is made easy by changing out air, water, and chemicals at various temperatures from outside of air stream.

The cleaner arm 200 can also act as a sprinkler system in the event of a fire, thus providing fire suppression capabilities.

Although certain preferred embodiments of the disclosure herein have been shown and described in detail, it should be understood that various changes and modifications may be made therein without departing from the scope of the appended claims.

What is claimed is:

1. A filter for removing a particulate material, comprising:
a collection system provided in an air stream to collect the particulate material, said collection system including a filter frame having a filter media;
a cleaning system provided to clean the collected particulate material from the filter media;
wherein said cleaning system includes a rotatable cleaner arm having a plurality of fluid nozzles.

2. The filter according to claim 1, wherein the filter media comprises a plurality of filter panels.

3. The filter according to claim 1, wherein the particulate material collects on a first surface of the filter media, said plurality of fluid nozzles being disposed to apply a fluid to a second surface of the filter media, the fluid passing through the filter media.

4. The filter according to claim 3, wherein the plurality of fluid nozzles are disposed at a distal end of the rotatable cleaner arm.

5. The filter according to claim 1, wherein the filter frame is semi-circular in shape.

6. The filter according to claim 5, wherein the particulate material collects on a first surface of the filter media and the rotatable cleaner arm rotates along an opposing second surface of the filter media.

7. The filter according to claim 6, wherein the filter media comprises a plurality of filter panels.
